(19) United States
(12) Patent Application Publication
(10) Pub. No.: US 2007/0055634 A1
(43) Pub. Date: Mar. 8, 2007

(54) Automated anonymous connection system (AACS) for facilitating business communication

(76) Inventor: Felipe Albertao, Mountain View, CA (US)

Correspondence Address: MORGAN & FINNEGAN, L.L.P., 3 World Financial Center, New York, NY, 10281-2101, US

(21) Appl. No.: 11/217,468

(22) Filed: Sep. 2, 2005

(51) Int. Cl. G06Q 99/00

(52) U.S. Cl. 705/74

(57) ABSTRACT

A system for enabling direct communication between potential clients and a pool of micro-entrepreneurs (contractors). A client enters information in the Automated Anonymous Connection System (AACS) regarding a job to be performed. The job information is automatically broadcast to all registered contractors capable of completing the job. The contractors receive a wireless notification of the job, and remit at least a quotation back to AACS, which compiles the quotation information and presents it to the client along with performance information. The client may then select a contractor and negotiate to have the work completed. The contractor is paid through AACS, and comments/responses related to the work completed may be logged to inform future clients.

### BACKGROUND OF THE INVENTION

1. Field of Invention

The present invention relates to a system for facilitating communications between unrelated parties, and more specifically, to systems for facilitating an anonymous connection perpetuating further communication between clients requesting job quotations from a pool of qualified contractors.

2. Description of Prior Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and business use, allowing users to transmit and receive voice, text and graphical data from a multitude of geographical locations. The communication networks utilized by devices span different frequencies and cover different broadcast distances, each having strengths desirable for various applications.

Cellular networks facilitate WCD communication over large geographic areas. These network technologies have commonly been divided by generations, starting with 1G analog cellular telephones first developed in the late 1970s to early 1980s that provided baseline voice communications, to the now emerging 4G streaming digital video content planned for the 2006-2007 timeframe. GSM is an example of a widely employed 2G digital cellular network communicating in the 900 MHZ-1.8 GHZ band in Europe and at 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB/H) will make streaming digital video, and other similar content, available via direct broadcast to a WCD. While Long-range communication networks like GSM are a well-accepted means for transmitting and receiving data, due to cost, traffic and legislative concerns, this type of network may not be appropriate for all data applications.

Short-range wireless networks provide communication solutions that avoid some of the problems seen in cellular networks. Bluetooth™ is an example of a short-range wireless technology quickly gaining acceptance in the marketplace. A Bluetooth™ enabled WCD transmits and receives data at a rate of 720 Kbps within a range of 10 meters, and may transmit up to 100 meters with additional power boosting. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members.

More recently, manufacturers have also began to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a tag or document. Machine-readable technologies such as radio frequency identification (RFID), Infra-red (IR) communication, optical character recognition (OCR) and various other types of visual, electronic and magnetic scanning are used to quickly input desired information into the WCD without the need for manual entry by a user.

The previously identified devices have been known to be widely employed in business settings, allowing company employees and other business professionals communicate with their offices, customers, clients, patients, suppliers, etc. These WCDs have evolved to meet the lofty demands of business professionals, integrating high level communication technologies with business, scheduling and other applications. However, this is a limited market. Popularity and convenience, coupled with a desire to tap into other potential users, have also created a demand for affordable baseline devices and service plans usable by a growing number of non-professional independent contractors.

These “micro-entrepreneurs” are often limited income laborers specializing in a certain areas such as painting, construction, plumbing, landscaping, home finishing and other trades-related areas. These contractors do not have resources such as offices with employees to handle incoming business inquiries. They often spend the majority of their time in the field at various job-sites. The conventional communication methods for these micro-entrepreneurs has been to list their contact number in a public directory (e.g., yellow pages, community bulletin board, etc.) They then must rely on a potential client, by verbal recommendation or possibly simply by chance, to select their number from amongst a large pool of eligible contractors. Calls often are not answerable from the site, requiring return calls and possibly lost business opportunities. Overall, the conventional method is a very inelegant and inefficient system.

What is needed is a system for facilitating effortless, and at least at the outset anonymous, communication between a potential client and a group of eligible contractors. The communication system should automate both the requesting and bidding processes to allow a potential client to select, based on ratings information, a contractor's bid from among the group of eligible contractors. The bid and confirmation information should immediately be communicated to the preferred contractor via wireless communication in order to expedite the completion of the requested project, and the client should be able to both pay the contractor and comment on the quality of the work completed all via the same automated system.

### SUMMARY OF INVENTION

The present invention consists of method, system, apparatus and computer program for facilitating anonymous communication between a potential client and a selected group of contractors. The communication system may include the ability for a client to request a quotation for a job, receive compiled quotation information along with performance information for each of the selected group of contractors, and transmit a quotation acceptance to a preferred contractor. The system may further allow the client to pay for and comment on the work done.

In at least one embodiment of the present invention, an Automated Anonymous Connection System (AACS) is provided to penetrate the existing communication barrier between a client side comprising potential clients looking to hire contractors, and a contractor side including groups of micro-entrepreneurs seeking to obtain new jobs while actively employed in the field. Information is collected from the client side including at least a description of the job to be completed. This information may then be broadcast to potential contractors specializing in a particular trade related to the job, or to contractors that have professed an ability to complete the job. The micro-entrepreneur may then bid on the job, wherein the bid includes at least a cost of completing the job. This information may then be compiled and returned to the client for evaluation.

The client evaluates quotations and performance information for each of the selected contractors. The performance information may include at least comments from previous clients in regard to the work completed by the various bidding contractors. After the client selects a micro-entrepreneur, an acceptance is returned to the contractor and the work may be completed accordingly. The client may remit the payment for the completed job via the AACS, as well as comments regarding the quality of the work completed by the contractor. The contractor also may have the opportunity to respond to any comments made by former clients to, for example, explain how or why a past situation occurred.

The system may interact with the various parties involved in the transaction via a multitude of different communication mediums. More specifically, the interfaces and mediums may be tailored to the environment of each user. For example, the client side may include an enhanced interface supporting access to databases related to past contractor jobs, links to Internet websites including pictures of past contractor jobs, certifications information for each micro-entrepreneur, etc. Conversely, the contractor side may be a simplified interface allowing for briefest interaction possible with the AACS on any wireless communication device. Such brief interaction may be required due to time and environmental constraints while the contractor is employed at another job site. These interfaces allow the client and contractor to correspond with the AACS according to their information needs in an environment tailored to a multitude of different communication devices.

### DESCRIPTION OF DRAWINGS

The invention will be further understood from the following detailed description of a preferred embodiment, taken in conjunction with appended drawings, in which:

FIG. 1 discloses a conventional interaction including obstacles involved in communication between a potential client and a number of possible contractors.

FIG. 2 discloses a conventional interaction including obstacles involved in communication between a potential client and a number of possible contractors including the advent of affordable wireless communication.

FIG. 3A discloses a modular description of an exemplary wireless communication device usable with at least one embodiment of the present invention.

FIG. 3B discloses a structural description of the exemplary wireless communication device previously described in FIG. 3A.

FIG. 4 discloses an exemplary improvement realized by the implementation of an embodiment of the present invention.

FIG. 5 discloses an exemplary communications layout, including both a client and contractor side, in accordance with at least one embodiment of the present invention.

FIG. 6A discloses an exemplary database structure, including both a client and contractor side, in accordance with at least one embodiment of the present invention.

FIG. 6B discloses the content of an exemplary user interface, including both the client and contractor side, in accordance with at least one embodiment of the present invention.

FIG. 7 discloses a flowchart describing the process wherein a client and a group of contractors interact in accordance with at least one embodiment of the present invention.

FIG. 8 discloses an exemplary application between a client and a contractor in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

I. Problems with Conventional Communications Between Clients and Contractors

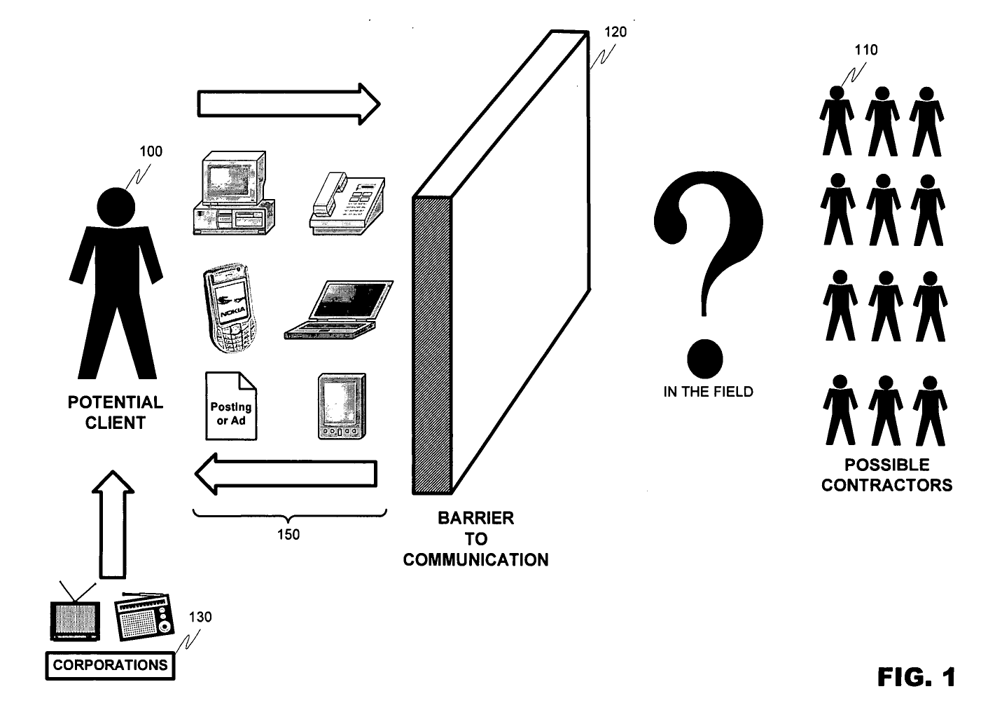

The conventional relationship between a potential client in search of a contractor and individual, possibly limited-income, tradesmen seeking to secure new jobs is fraught with obstacles impeding communication. FIG. 1 helps to explain the conventional situation wherein a potential client requires service without the improvements offered by the present invention.

Potential client 100 desires to hire a possible contractor 110 to complete a job. A number of different communication resources 150 are available to the client including, but not limited to, a desktop or laptop computer communicating over a wide area network (WAN) such as the Internet, standard telephonic communications, cellular communications or even a simple posting or advertisement on a local bulletin board, in a newspaper, etc. On the contractor side, the micro-entrepreneur 10 is one of a number of independent, and possibly low-income, contractors laboring daily at one or more job sites (“in the field”). A “barrier to communication” 120 is represented metaphorically in FIG. 1 as a wall between the two sides, and symbolizes the inability of the potential client 100 to effectively communicate with the possible contractor 100.

While client 100 benefits from a number of available communication options, there is no guarantee that any of these mediums will be able to directly reach contractors 110. This immediately creates a disadvantage for contractors 110. Often low-income tradesmen must list their home telephone number for business matters, and since they are in the field all day, a frustrating situation requiring answering service messages and return telephone calls may occur. As a result, contractors 110 may lose business to larger companies or corporations 130 that offer the same services. These corporations 130 may charge more to complete the job than contractors 110, however, they get the business because they have an office staff immediately available to interact with client 100 and may also directly access potential clients 100 via advertisements on television, radio, etc. Contractors 110 may also be disadvantaged due to the fact that client 100 tends to trust the advertisements of larger commercial companies 130 over an independent contractors 110. A micro-entrepreneur must often rely on word-of-mouth recommendations in order to secure new jobs. Hence, the “barrier” 120 is a formidable challenge that contractors 110 must overcome.

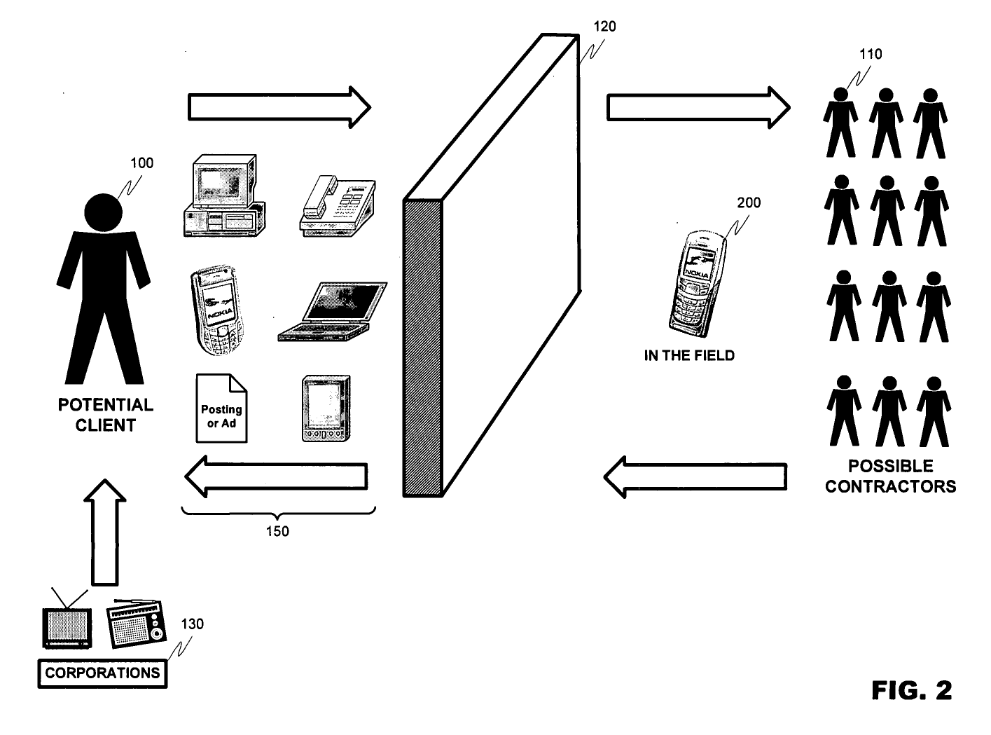

FIG. 2 introduces the effect of affordable cellular service and WCDs to the pool of contractors 110. As previously discussed, the maturity and popularity of cellular communication has made it possible for even limited income individuals to own a wireless device like WCD 200. Contractors 110 may now have a device providing the ability to communicate regardless of their location. However, the “barrier to communication” 120 is still a problem because having the ability to communicate only solves one of the aforementioned obstacles. While contractors 110 can receive calls dealing with existing customers and the potential clients that happen upon their telephone number by chance, or are referred by previous customers, they must still deal with the inability to effectively communicate with the large pool of potential clients and compete against larger companies 130 with the resources to service the client immediately and provide the client with information, advertising, etc. What is needed, therefore, is a way to leverage the micro-entrepreneur's newly available in-field communication abilities so that they can become more readily available to the growing group of technically proficient potential clients seeking their services.

II. Wireless Communication Device

It is first important to understand the communication tools available to contractors 110 in the field before exploring the present invention. The data handling capabilities of wireless communication devices play an important role in the transaction between the client 100 and the contractor 110.

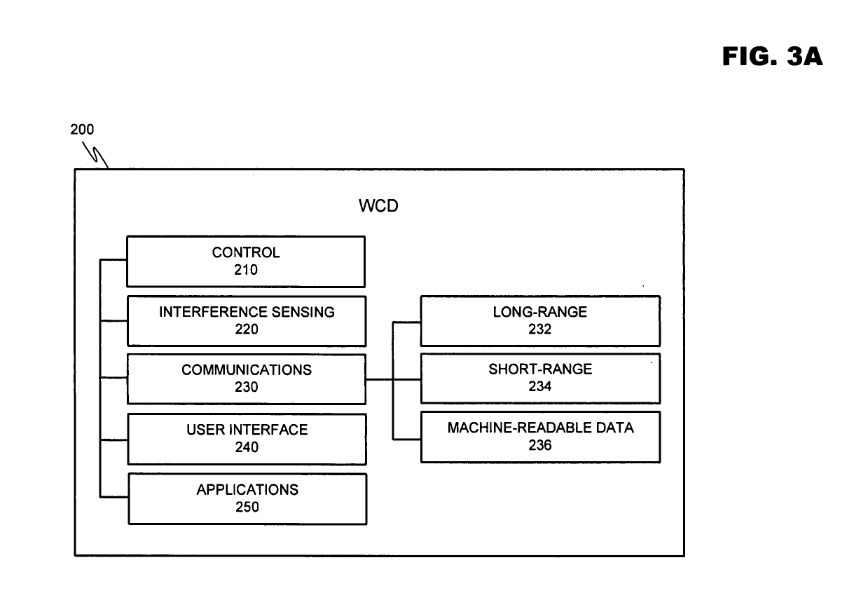

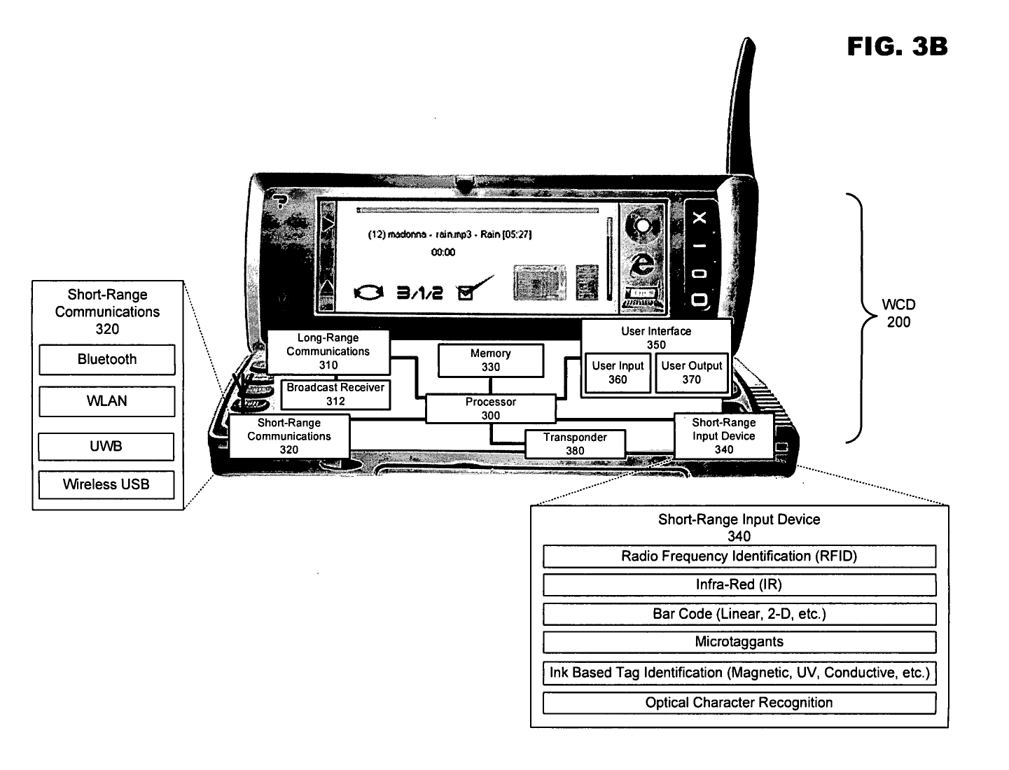

FIG. 3A discloses an exemplary modular layout for a wireless communication device usable with the instant invention. WCD 200 is broken down into modules representing the functional aspects of the device. These functions may be performed by the various combinations of software and/or hardware components discussed below.

Control module 210 regulates the operation of the device. Inputs may be received from various other modules included within WCD 200. For example, interference sensing module 220 may use various techniques known in the art to sense sources of environmental interference within the effective transmission range of the wireless communication device. Control module 210 interprets these data inputs and in response may issue control commands to the other modules in WCD 200.

Communications module 230 incorporates all of the communications aspects of WCD 200. As shown in FIG. 3A, communications module 230 includes for example long-range communications module 232, short-range communications module 234 and machine-readable data module 236. Communications module 230 utilizes at least these sub-modules to receive a multitude of different types of communication from both local and long distance sources, and to transmit data to recipient devices within the broadcast range of WCD 200. Communications module 230 may be triggered by control module 210 or by control resources local to the module responding to sensed messages, environmental influences and/or other devices in proximity to WCD 200.

User interface module 240 includes visual, audible and tactile elements which allow the user of WCD 200 to receive data from, and enter data into, the device. The data entered by the user may be interpreted by control module 210 to affect the behavior of WCD 200. User inputted data may also be transmitted by communications module 230 to other devices within effective transmission range. Other devices in transmission range may also send information to WCD 200 via communications module 230, and control module 210 may cause this information to be transferred to user interface module 240 for presentment to the user.

Applications module 250 incorporates all other hardware and/or software applications on WCD 200. These applications may include sensors, interfaces, utilities, interpreters, data applications, etc., and may be invoked by control module 210 to read information provided by the various modules and in turn supply information to requesting modules in WCD 200.

FIG. 3B discloses an exemplary structural layout of WCD 200 according to an embodiment of the present invention that may be used to implement the functionality of the modular system previously described. Processor 300 controls overall device operation. As shown in FIG. 3B, processor 300 is coupled to communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communications utilities modules required to support WCD 200.

Long-range communications 310 performs functions related to the exchange of information over large geographic areas (such as cellular networks) via an antenna. These communication methods include technologies from the previously described 1G to 3G and soon fourth generation streaming video transmission. In addition to basic voice communications (e.g., via GSM), long-range communications 310 may operate to establish data communications sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300 (not pictured), broadcast receiver 312 allows WCD 200 or receive broadcast messages via mediums such as Digital Video Broadcast for Handheld Devices (DVB/H). These transmissions may be encoded so that only certain designated receiving devices may access the broadcast content, and may contain text, audio or video information. In at least one example, WCD 200 may receive these broadcasts and use information contained within the broadcast signal to determine if the device is permitted to view the received content.

Short-range communications 320 is responsible for functions involving the exchange of information across short-range wireless networks. As described above and depicted in FIG. 3B, examples of such short-range communications 320 are not limited to Bluetooth™, WLAN, UWB and Wireless USB connections. Accordingly, short-range communications 320 performs functions related to the establishment of short-range connections, as well as processing related to the transmission and reception of information via such connections.

Short-range input device 340, also depicted in FIG. 3B, may provide functionality related to the short-range scanning of machine-readable data. For example, processor 300 may control short-range input device 340 to generate RF signals for activating an RFID transponder, and may in turn control the reception of signals from an RFID transponder. Other short-range scanning methods for reading machine-readable data that may be supported by the short-range input device 340 are not limited to IR communications, linear and 2-D bar code readers (including processes related to interpreting UPC labels), and optical character recognition devices for reading magnetic, V, conductive or other types of coded data that may be provided in a tag using suitable ink. In order for the short-range input device 340 to scan the aforementioned types of machine-readable data, the input device may include optical detectors, magnetic detectors, CCDs or other sensors known in the art for interpreting machine-readable information.

Further shown in FIG. 3B, user interface 350 is also coupled to processor 300. User interface 350 facilitates the exchange of information with a user. FIG. 3B shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 200 may also include transponder 380. This is essentially a passive device which may be programmed by processor 300 with information to be delivered in response to a scan from an outside source. For example, an RFID scanner mounted in a entryway may continuously emit radio frequency waves. When a person with a device containing transponder 380 walks through the door, the transponder is energized and may respond with information identifying the device, the person, etc.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communications components stored in memory 330.

The elements shown in FIG. 3B may be constituted and coupled according to various techniques in order to produce the functionality described in FIG. 3A. One such technique involves coupling separate hardware components corresponding to processor 300, communications sections 310, 312 and 320, memory 330, short-range input device 340, user interface 350, transponder 380, etc. through one or more bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communications utilities software component, also contained in memory 330, which provides for the establishment of service sessions using long-range communications 310 and/or short-range communications 320. The communications utilities component may include various routines that allow the reception of services from remote devices according to mediums, such as the Wireless Application Medium (WAP).

When engaging in WAP communications with a remote server, the device functions as a WAP client. To provide this functionality, the software components may include WAP client software components, such as a Wireless Markup Language (WML) Browser, a WMLScript engine, a Push Subsystem, and a Wireless Medium Stack.

Applications (not shown) may interact with the WAP client software to provide a variety of communications services. Examples of such communications services include the reception of Internet-based content, such as headline news, exchange rates, sports results, stock quotes, weather forecasts, multilingual phrase dictionaries, shopping and dining information, local transit (e.g., bus, train, and/or subway) schedules, personal online calendars, and online travel and banking services.

The WAP-enabled device may access small files called decks which each include smaller pages called cards. Cards are small enough to fit into a small display area that is referred to herein as a microbrowser. The small size of the microbrowser and the small file sizes are suitable for accommodating low memory devices and low-bandwidth communications constraints imposed by wireless links.

Cards are written in the Wireless Markup Language (WML), which is specifically devised for small screens and one-hand navigation without a keyboard. WML is scaleable so that it is compatible with a wide range of displays that covers two-line text displays, as well as large LCD screens found on devices, such as smart phones, PDAs, and personal communicators. WML cards may include programs written in WMLScript, which is similar to JavaScript. However, through the elimination of several unnecessary functions found in these other scripting languages, WMLScript reduces memory and processing demands.

III. Automated Anonymous Connection System (AACS)

AACS, in at least one embodiment of the present invention, includes a system and method for alleviating the previously indicated problems in the prior art. AACS empowers the common people by helping them to become more productive in their everyday pursuits.

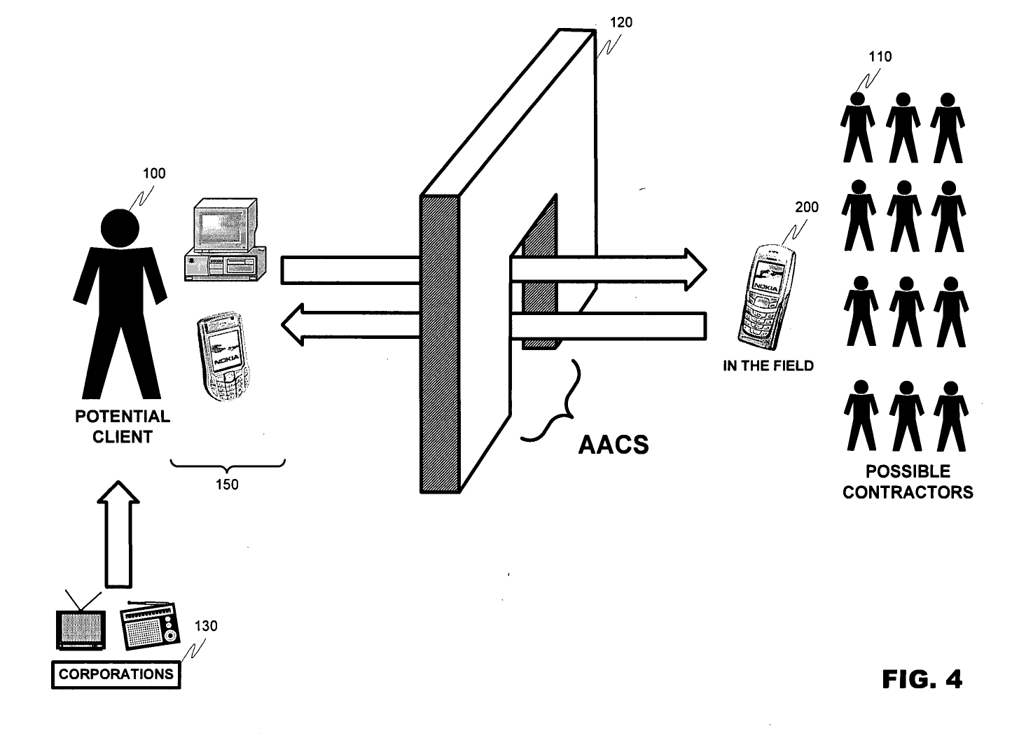

FIG. 4 depicts at least one benefit realized by embodiments of the present invention. As previously shown in FIGS. 1 and 2, potential client 100 and possible contractors 110 were separated by “barrier to communication” 120 that impeded the progress of business transactions. However, the AACS creates a means for client and contractor to circumvent this barrier and communicate directly. In this way, AACS, in at least one embodiment, allows potential client 100 desiring assistance with a job to express this desire directly to all eligible contractors 110, allowing these micro-entrepreneurs to respond accordingly. A business relationship may be established in an efficient manner, even though the contractor may be communicating from the field, for example, from another job site.

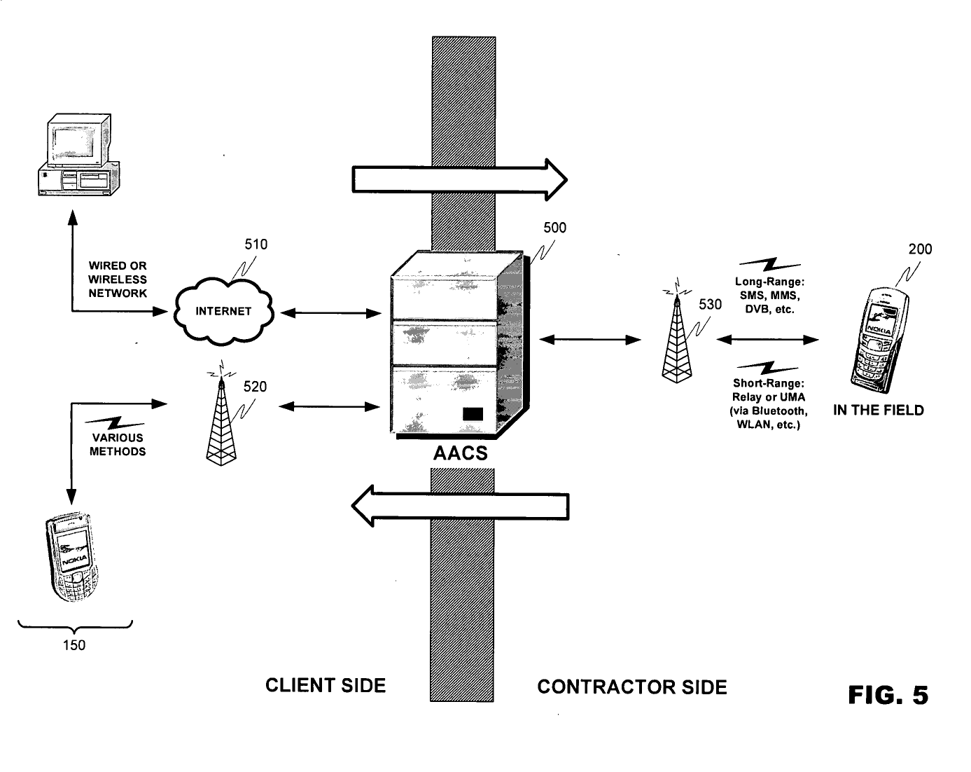

AACS is an intervening actor between client 100 and contractors 110 helping to organize, enhance and streamline the flow of information between the two parties. FIG. 5 shows an exemplary communications layout usable in embodiments of the present invention. Client communication devices 150 may include anything from a stationary desktop computer to a portable WCD. For example, a computer may be hardwired or may communicate via a wireless local area network (WLAN) over the Internet to AACS 500. Alternatively, a WCD may communicate via wireless system 520 to AACS 500. Wireless system 520 may include any of the long or short range communication technologies previously discussed. AACS receives information from these devices, and based on this information may broadcast information out to a selected group of contractors 110 registered in certain trade or occupation categories in AACS 500. This information may be transmitted by wireless system 530 to the contractor's WCD 200. Wireless system 530 may include any of the long or short range communication technologies previously discussed. Exemplary long-range communication technologies include SMS, MMS, DVB, etc. Alternatively, if contractor is located in an area inaccessible to long-range communications (e.g., inside a building), a short-range communication relay technology such as the Unlicensed Mobile Access (UMA) model may be used to relay messages to AACS using short-range communications such as Bluetooth, WLAN, etc. in combination with a wide area network (WAN) connection. The use of text messaging technology, in general, has become commonplace on many base WCD models, and therefore ensures that micro-entrepreneurs of all income levels will be able to make use of AACS 500.

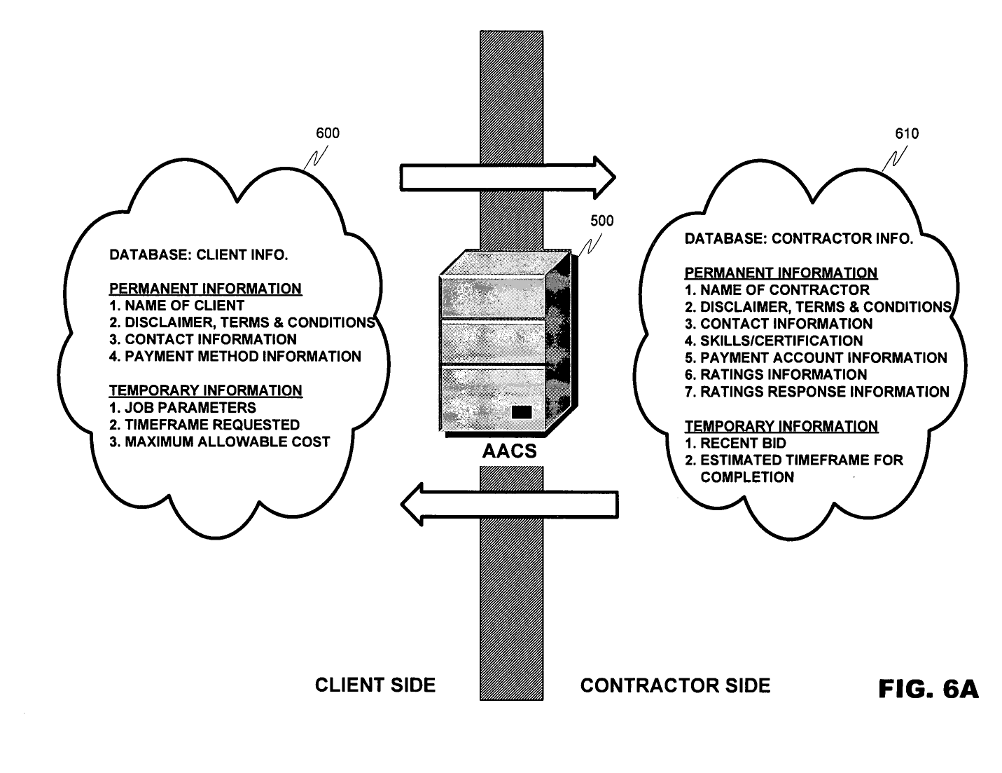

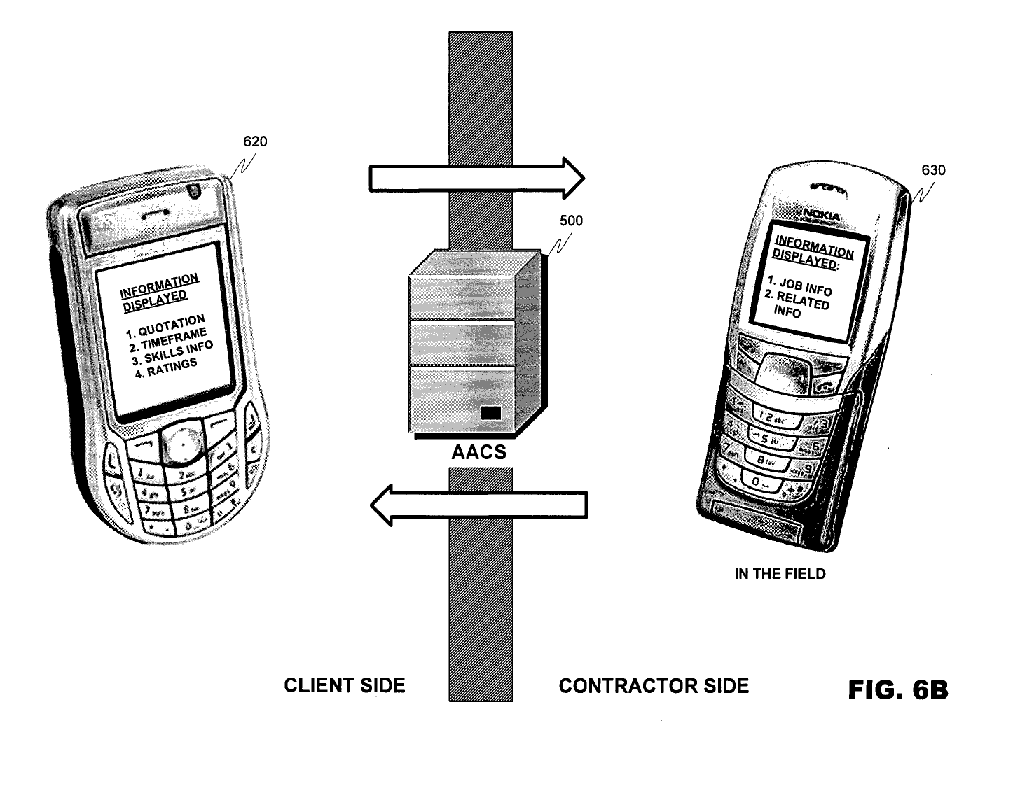

AACS 500 stores both registration and job-specific information input by both the client 100 and the contractors 110. This information is used to determine a group of contractors that should receive information about potential jobs. FIG. 6A describes exemplary information stored by AACS 500 in at least one embodiment of the present invention.

Client side database 600 includes information related to potential client 100. Permanent information may include such standard registration data as the name of the client, disclaimer/terms and conditions information including a signoff by the client to use AACS 500, contact information for the client and payment method information. It is important to note that at least one embodiment of the present invention includes a client 100 paying a contractor 110 electronically through AACS 500 (e.g., via credit card, paypal, etc.) This provision allows the AACS provider to retain a small percentage of the payment to account for the communications services provided. A retained percentage system allows micro-entrepreneurs of all income levels to participate in the service without having to pay any up-front or reoccurring registration fees. The temporary information entered by client 100 may include job specific data, such as a description of the work to be done, the timeframe in which the client desires to have the job completed, a maximum allowable cost for the job, etc.

Contractor side database 610 includes information related to contractors 110. Information permanently stored in the database may include standard registration items such as name of the contractor, disclaimer/terms and conditions information including a signoff by the contractor to use AACS 500 and contact information. Skills/certification information may, for example, include a selector or checklist of different job types that may be requested by client 100. In this way, the system may determine if the particular contractor 110 has the skills and/or certifications required to perform the job requested. All of the contractors 110 in AACS 500 may then receive job quotation requests via a broadcast message, for instance via SMS, MMS, or encoded DVB/H, based on the entered credentials. Payment account information is required so that the electronic payment made through AACS 500 may be deposited in the contractor's account. Ratings information may include numeric ratings and/or textual comments entered on the system from customer's rating the contractor's work. This information is stored in database 610 and may be later viewed by potential clients 100 considering a contractor 110 for a job. Contractors 110 have the opportunity to respond to these client comments, and these responses may be displayed along with the client comments for potential clients 100, giving them a perspective concerning what may have happened in that specific situation. Temporary information in contractor side database 610 is related to specific jobs in which contractor 110 has interest. This information may include the most recent bid the contractor made for a job and the timeframe in which the contractor estimates the job can be completed.

Not all of the information shown in FIG. 6A is displayed during the transaction between client 100 and contractors 110. Client 100 is able to access information related to all of the bidding contractors prior selecting one of the bidding contractors 110, however, the identity of client 100 is kept anonymous to contractors 110 until a job quotation is accepted by the client. Exemplary information that may be viewed by each party is shown in FIG. 6B. A device 620 is disclosed wherein client 100 may view information including a quotation from a contractor, the estimated time of completion of the job, skills information related to completing the job and ratings from previous clients of contractor 110. Depending upon the capabilities of the communication device being utilized by client 100, additional information may be available. For example, a potential client accessing AACS 500 using a computer on a high speed Internet connection may also be able to access hyperlinks to pictures of a contractor's previous jobs, references for a contractor, products and/or processes used by a contractor, etc. This information may be established when a contractor first registers with AACS 500. An exemplary contractor side user interface is shown at 630. The contractor interface is greatly abbreviated due to the operational requirement of functioning on a multitude of baseline devices (e.g., lower priced cellular telephones). Only information related to the particular job to quote is displayed. The information may include, but is not limited to, the type of work, the location of the job site and the desired completion date of the job (depending on the capability of the device). The contractor may respond to the request by keying in a bid price, for example “2-0-0” for $200.00, and sending this message back to AACS 500 via SMS or MMS. Alternatively, if contractor 110 is not interested, they may key “0” for no bid. In at least one embodiment of the invention, contractor 110 may also key-in an estimated completion date, or select a completion date from a number of listed options, if their WCD 200 allows for such functionality.

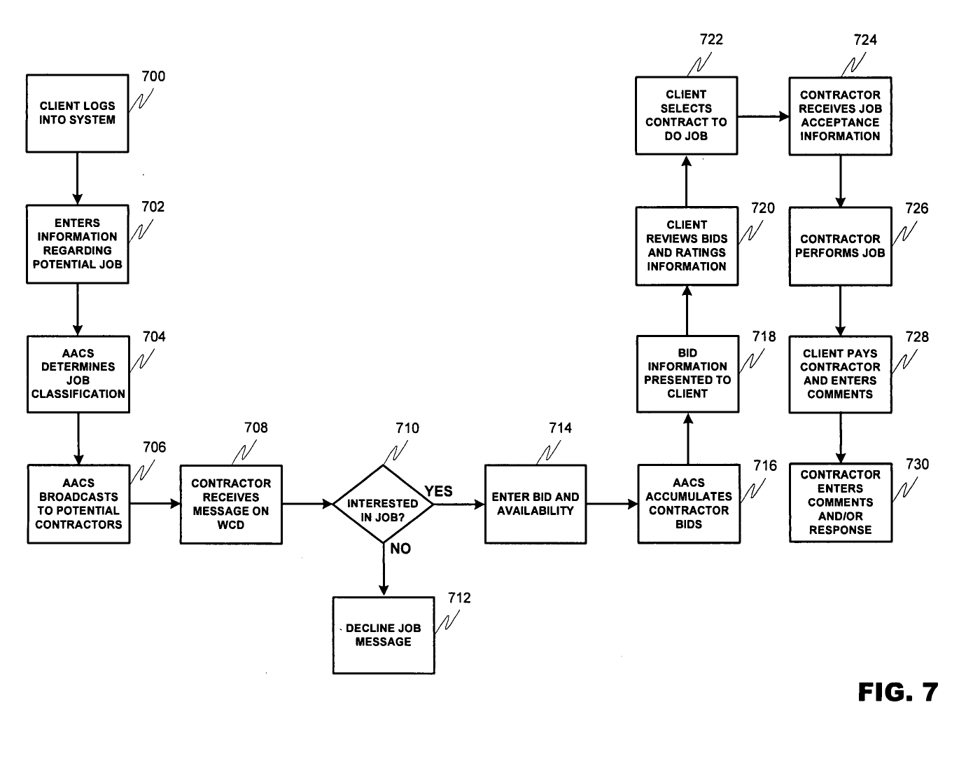

A flow chart explaining the process of at least one embodiment of the present invention is disclosed in FIG. 7. Step 700 begins the process, wherein potential client 100 logs into the system (we assume in this flowchart that the client has already progressed through any initial registration steps required to use AACS 500). The client then enters information regarding a job to be completed. This information may be in the form of both information selected from general categories (e.g., painter, roofer, kitchen remodeling, etc.) and textual information supplied by client 100 (step 702). AACS 500 uses this information in step 704 to determine which contractors 110 should receive an information request concerning the job. In this computation, AACS 500 may compare job information in the client side database 600 to skills/certifications information entered in contractor side database 610. Once the appropriate contractors 110 are determined, AACS 500 may broadcast this information to the selected contractor group in step 706.

Contractors 110 in the selected contractor group presumably have WCD 200 with them while working in the field. Textual information, for example via SMS or MMS, is received in WCD 200 regarding the potential work opportunity (step 708). In at least one embodiment of the invention, potential client 100 is not disclosed to contractors 110. A briefjob description is displayed for contractor 110, and in step 710 a decision is made whether to bid on the job. If the job is declined, a message (e.g., “0”) may be sent to AACS 500 closing the bid (step 712). Otherwise, the contractor may enter bid information and depending on the capability of the WCD, availability information in step 714.

AACS 500 accumulates the bid information and presents it to the user in a compiled form in steps 716 and 718. The information may include bid and availability information, as well as links to reviews, responses and/or other information relevant to a contractor. In step 720, client 100 reviews these bids, ratings, responses, etc. and picks a contractor 110 to do the job. AACS 500 remits an acceptance to the selected contractor in step 722 that may include address and contact information for client 100.

The micro-entrepreneur tradesman may then perform the contracted job for client 100 (step 726). Communication may now be direct between client 10 and contractor 110 since the identities of both parties are known. When the job is completed, client 100 uses AACS 500 to remit payment for the job to contractor 110. Step 728 also includes the ability for client 100 to enter ratings or comments in regard to the performance of contractor 110. Contractor 110 may view this information, and respond accordingly in step 730 if they feel the comments require justification or if they feel client 100 was overly critical.

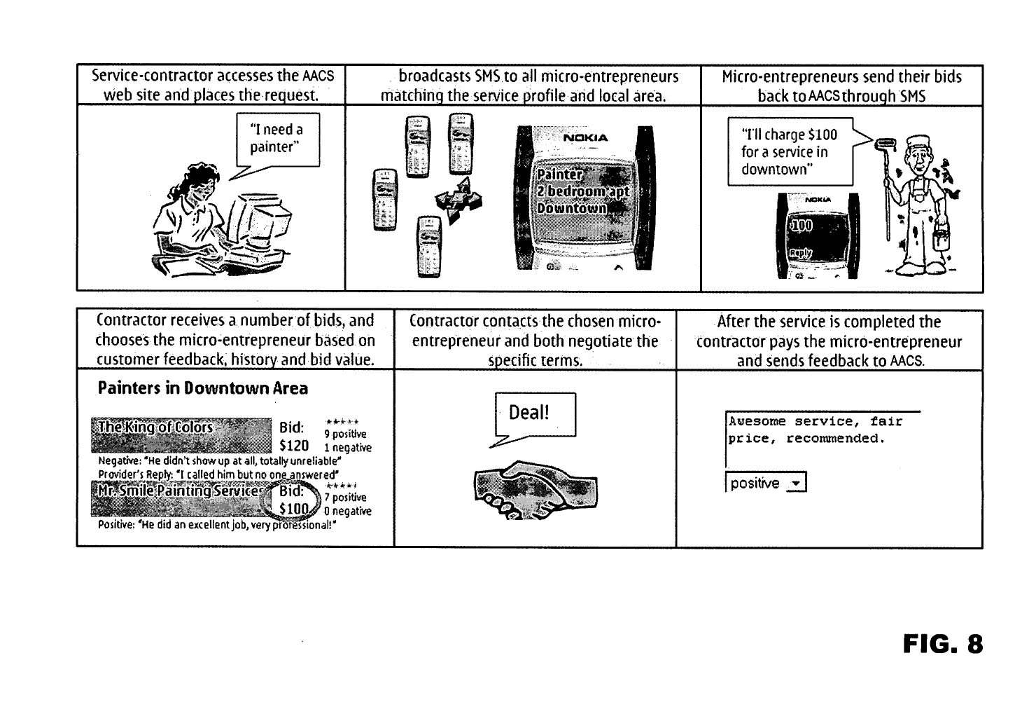

FIG. 8 discloses an example of the actual practice of at least one embodiment of the present invention. In this scenario a potential client needs a painter. She logs into AACS via the Internet and enters job information from her desktop computer. AACS searches the database and determines all contractors that have the ability to perform a painting job per the client's requirements. AACS then broadcasts a bid request message to a group of selected contractors.

A contractor (micro-entrepreneur) views the abbreviated request on his cellular phone and replies that he can do the job for $100.00. This bid is compiled with other contractor bids and is presented to the client along with any available comments regarding each contractor. The client then accepts a bid and the two parties negotiate a final deal.

The job is performed by the selected micro-entrepreneur, and payment is made. In the presented transaction, the client also enters information regarding her satisfaction with the contractor's performance. This information may be made available to future clients seeking the same services.

The present invention is an improvement over the prior art in that it allows clients and contractors to surpass the obstacles to communication that currently inhibit the pursuits of both parties. The client would like to obtain a reputable contractor at the lowest possible price without having to manually contact numerous contractors and compile their bid information. The contractors require an automated system that will allow them to both receive information related to various job opportunities, and transmit bid information in response to the job information, all while working at a job site. AACS accommodates all of these requirements in an automated, expedient and efficient manner.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

1. A method for providing a virtual marketplace, comprising:
maintaining information related to registered contractors;
providing an interface for making a service request to the registered contractors;
comparing the service request with the information related to registered contractors to form a group of selected contractors;
broadcasting the service request, without identifying a source of the request, to the group of selected contractors via wireless communication;
collecting service offers from the group of selected contractors via wireless communication;
providing an interface for reviewing the collected service offers; and
providing further communication with a preferred one of the group of selected contractors.

2. The method of claim 1, wherein the information related to registered contractors includes at least name information, contact information, payment account information, skills and/or certifications information, and performance information.

3. The method of claim 1, wherein the interface for making a service request includes at least an area to input a job description.

4. The method of claim 1, wherein comparing the service request to the information related to the registered contractors includes at least matching a job description to skills and/or certifications information of the registered contractors.

5. The method of claim 1, wherein the wireless communication for broadcasting the service request to the group of selected contractors occurs via at least one of a cellular network, a digital broadcast network and a short-range relay network.

6. The method of claim 1, wherein the wireless communication for collecting service offers from the group of selected contractors occurs via at least one of a cellular network and a short-range relay network.

7. The method of claim 1, wherein the collected service offers include at least bid information.

8. The method of claim 7, wherein the interface for viewing the collected service offers includes the bid information and contractor performance information for each of the group of selected contractors, the contractor performance information further including at least one of ratings information and ratings response information.

9. The method of claim 1, wherein providing further communications with the preferred one of the group of selected contractors includes providing contact information for the source of the service request to the preferred one of the group of selected contractors.

10. The method of claim 9, wherein the further communication with the preferred one of the group of selected contractors occurs via at least one of a wireless cellular communication or short-range relay communication.

11. An apparatus for providing a virtual marketplace, comprising:
a memory for maintaining information related to registered contractors;
an interface for enabling a client to formulate a service request to the registered contractors;
control logic for comparing the service request with the information related to registered contractors to form a group of selected contractors;
a transmitter for broadcasting the service request, without identifying the client, to the group of selected contractors via wireless communication;
a receiver for collecting service offers from the group of selected contractors via wireless communication;
an interface for enabling review of the collected service offers by the client; and
control logic for providing further communication with a preferred one of the group of selected contractors to the client.

12. The apparatus of claim 11, wherein the information related to registered contractors includes at least name information, contact information, payment account information, skills and/or certifications information, and performance information.

13. The apparatus of claim 11, wherein the interface for making a service request includes at least an area to input a job description.

14. The apparatus of claim 11, wherein comparing the service request to the information related to the registered contractors includes at least matching a job description to skills and/or certifications information of the registered contractors.

15. The apparatus of claim 11, wherein the wireless communication for broadcasting the service request to the group of selected contractors occurs via at least one of a cellular network, a digital broadcast network and a short-range relay network.

16. The apparatus of claim 11, wherein the wireless communication for collecting service offers from the group of selected, contractors occurs via at least one of a cellular network and a short-range relay network.

17. The apparatus of claim 11, wherein the collected service offers include at least bid information.

18. The apparatus of claim 17, wherein the interface for viewing the collected service offers includes the bid information and contractor performance information for each of the group of selected contractors, the contractor performance information further including at least one of ratings information and ratings response information.

19. The apparatus of claim 11, wherein providing further communications with the preferred one of the group of selected contractors includes providing contact information for the client to the preferred one of the group of selected contractors.

20. The apparatus of claim 19, wherein the further communication with the preferred one of the group of selected contractors occurs via at least one of a cellular communication and a short-range relay communication.

21. A computer program product comprising a computer usable medium having computer readable program code embodied in said medium for providing a virtual marketplace, comprising:
a computer readable program code for maintaining information related to registered contractors;
a computer readable program code for providing an interface for making a service request to the registered contractors;
a computer readable program code for comparing the service request with the information related to registered contractors to form a group of selected contractors;
a computer readable program code for broadcasting the service request, without identifying a source of the request, to the group of selected contractors via wireless communication;
a computer readable program code for collecting service offers from the group of selected contractors via wireless communication;
a computer readable program code for providing an interface for reviewing the collected service offers; and
a computer readable program code for providing further communication with a preferred one of the group of selected contractors.

22. The computer program product of claim 21, wherein the information related to registered contractors includes at least name information, contact information, payment account information, skills and/or certifications information, and performance information.

23. The computer program product of claim 21, wherein the interface for making a service request includes at least an area to input a job description.

24. The computer program product of claim 21, wherein comparing the service request to the information related to the registered contractors includes at least matching a job description to skills and/or certifications information of the registered contractors.

25. The computer program product of claim 21, wherein the wireless communication for broadcasting the service request to the group of selected contractors occurs via at least one of a cellular network, a digital broadcast network and a short-range relay network.

26. The computer program product of claim 21, wherein the wireless communication for collecting service offers from the group of selected contractors occurs via at least one of a cellular network and a short-range relay network.

27. The computer program product of claim 21, wherein the collected service offers include at least bid information.

28. The computer program product of claim 27, wherein the interface for viewing the collected service offers includes the bid information and contractor performance information for each of the group of selected contractors, the contractor performance information further including at least one of ratings information and ratings response information.

29. The computer program product of claim 21, wherein providing further communications with the preferred one of the group of selected contractors includes providing contact information for the source of the service request to the preferred one of the group of selected contractors.

30. The computer program product of claim 29, wherein the further communication with the preferred one of the group of selected contractors occurs via at least one of a cellular communication and a short-range relay communication.

31. A system for providing a virtual marketplace, comprising:
a control system;
a client communication device;
contractor communication devices;
the control system maintaining information related to registered contractors, and for further providing an interface to the client communication device for making a service request to the registered contractors;
the client communication device sending a service request to the control system, wherein the service request is compared to the information related to registered contractors to form a group of selected contractors;
the control system broadcasting the service request, without identifying the source of the request, to the contractor wireless communication device of each one of the group of selected contractors via wireless communication;
the contractor communication devices sending service offers from the group of selected contractors to the control system via wireless communication;
the control system providing an interface for reviewing the collected service offers on the client communication device and for further providing communication with a preferred one of the group of selected contractors.

32. The system of claim 31, wherein the wireless communication occurs via a cellular network.
